(19) United States
(12) Patent Application Publication
(10) Pub. No.: US 2018/0073870 A1
(43) Pub. Date: Mar. 15, 2018

(54) METHOD AND SYSTEM FOR MEASURING SUBSIDENCE

(71) Applicant: OCTIO AS, Bergen (NO)

(72) Inventors: Helge BRANDSAETER, Hamresanden (NO); Bjarte FAGERÅS, Fana (NO); Magne OLDERVOLL, Os (NO); Leon LØVHEIM, Bergen (NO); John Even LINDGÅRD, Harstad (NO)

(21) Appl. No.: 15/564,615

(22) PCT Filed: Apr. 8, 2016
(86) PCT No.: PCT/NO2016/050066

§ 371 Date: Oct. 5, 2017

(30) Foreign Application Priority Data
Apr. 10, 2015 (NO) 20150430

(51) Int. Cl. G01B 21/20; G01V 1/38

(52) U.S. Cl. CPC G01B 21/20; G01V 2210/1427; G01V 1/3852; G01V 1/3808

(57) ABSTRACT

A method for measuring subsidence and/or uprise on a field, comprises the steps of: deploying at least one cable on a solid surface; collecting inline tilt data from numerous tilt sensors deployed along each cable (100); and performing a statistical analysis on the tilt data to determine changes in curvature on the solid surface. Preferably, the statistical method involves computing a cumulative inline and/or cross-line tilt, whereby random errors cancel and systematic changes add. In addition, regression and/or interpolation may provide a quantitative estimate of curvature etc.

### BACKGROUND

### Field of the Invention

The present invention concerns measurements of subsidence or uplift by tilt sensors.

### Prior and Related Art

Permanent reservoir monitoring (PRM) aims at tracking changes in a subsurface structure over time, and/or during particular operations such as well treatment or injection. PRM may include microseismic and other geo-mechanical monitoring, and is not necessarily limited to a production field. For example, subsurface structures used for waste depositing or long term storage of CO2 may be monitored by the same methods and systems described herein.

Subsidence and/or uplift of the seafloor is an issue in many of these applications where fluids are produced, replaced or injected onshore or offshore. For example, continuous measurement on a production field in order to detect movements in the overburden is important in understanding the depletion of the underlying subsurface formation as well as to detect any possible subsidence having an impact on the infrastructure on the seafloor.

Subsidence or uplift may be monitored by hydro-acoustic methods, measurements of pressure changes at the seafloor or by tilt-meters. The present invention relates to tilt measurements.

In a known PRM-system provided by the applicant of the present invention, sensor stations are distributed over the reservoir in a large grid connected by cable. Data from each station is transferred to surface by cable in real time. Each sensor station could include a number of different type sensors. However, a basic system will at least include seismic sensors. The seismic sensor is preferably a 4-component sensor with a hydrophone and a 3-component particle velocity or acceleration sensor (accelerometer). A tilt sensor is often provided to measure the orientation of the 3-component system relative to the vertical. However, these tilt sensors are of a relatively inexpensive type, designed for different purposes, and typically do not have the required accuracy for tilt measurements in order to detect subsidence or uplift.

U.S. Pat. No. 7,028,772 B2 discloses a treatment well tilt-meter system with one or more tilt-meter assemblies located within an active treatment well. The system provides data from the downhole tilt-meters, and can be used to map hydraulic fracture growth or other subsurface processes from the collected downhole tilt data versus time. The system provides tilt data inversion of data from each of the tilt-meter assemblies, and provides isolation of data signals from noise associated with the treatment well environment. The system also provides geo-mechanical modelling for treatment well processes.

WO 2005/089404 discloses a system with a component array located within the borehole of an active well, in the borehole of a nearby offset well or in multiple shallow boreholes in the surface around the active well. In one embodiment, the system includes a sensor array with at least one tilt sensor, at least one microseismic sensor and a transmitter for transmitting data to a receiver. Received microseismic data are analysed to find a location of a microseismic event, and received tilt-meter data are analysed to ascertain orientation and dimension of a fracture developed during said at least one geophysical process.

The above systems are commercially available from Pinnacle, a subsidiary of Halliburton, and represent the state of the art. However, the systems require accurate instruments, i.e. tilt-meters, which can withstand the temperature, pressure and chemicals in an active well and/or drilling shallow boreholes. These systems are relatively complex and expensive and are usually deployed as a single instrument or a very limited number of instruments. There is a need for a less costly system for monitoring a solid surface above a subsurface formation.

The objective of the present invention is to provide a method and a system for measuring tilt on a field that solves or alleviates at least one of the aforementioned problems and shortcomings.

### SUMMARY OF THE INVENTION

This objective is achieved by a method according to claim 1 and a system according to claim 9.

In a first aspect, the invention concerns a method for measuring subsidence and/or uprise on a field. The method comprises the steps of: deploying at least one cable on a solid surface; collecting inline tilt data from numerous tilt sensors deployed along each cable; and performing a statistical analysis on the tilt data to determine changes in curvature on the solid surface.

In one embodiment, the statistical analysis involves computing a cumulative inline tilt as a sum of collected tilt data from tilt sensors disposed along one cable.

This embodiment may further comprise the step of adding several cumulative inline tilts.

In an alternative embodiment, the statistical analysis involves computing a cumulative cross-line tilt as a sum of collected tilt data from tilt sensors disposed along one cross-line extending perpendicular to several essentially parallel cables.

This embodiment may further comprise the step of adding several cumulative cross-line tilts.

In all embodiments above, the steps may be repeated at predetermined intervals.

In addition to the statistical analysis, the method may further comprise the step of performing a regression analysis on the tilt data in order to obtain an estimate of a curvature on the solid surface.

The sign of tilt data may be conserved to provide a difference between subsidence and uplift.

In a second aspect, the invention concerns a system using the method described above. The system comprises several cables with seismic stations arranged at regular intervals. Each seismic station comprises a tilt sensor and the cables are arranged essentially parallel in an array. Moreover, each seismic station is connected through the array, a base station and an umbilical to a control unit performing the method. The solid surface may be a seafloor above a subsurface formation to be monitored.

Further features and advantages will become apparent from the dependent claims and the detailed description below.

### BRIEF DESCRIPTION OF THE DRAWINGS

The invention will be explained by means of examples and reference to the drawings, in which:

FIG. 1 illustrates basic principles of the invention.

### DETAILED DESCRIPTION

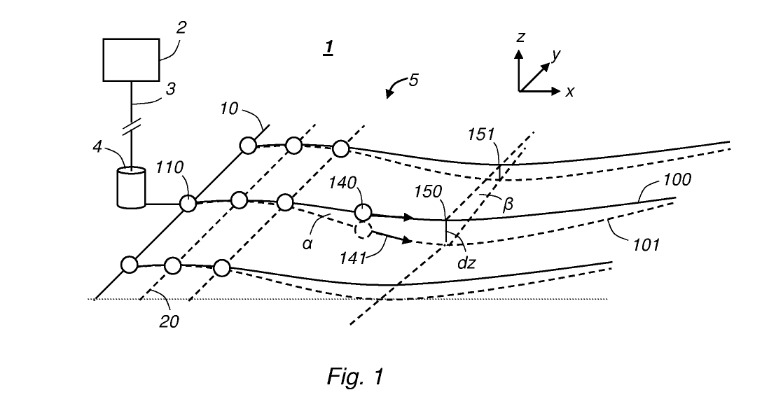

FIG. 1 shows a system 1 comprising a control unit 2 providing power and two-way communication to a seismic array 5 through an umbilical 3 and a base station 4. The seismic array 5 is deployed at a solid surface, e.g. a seafloor, and comprises cables 100 running essentially in the horizontal direction denoted x. A cable 10 on the surface essentially perpendicular to the cable 100, i.e. in the direction denoted y, connects the cables 100 to the base station 4.

Each cable 100 provides several seismic stations 110, 140 with power and communication. Seismic stations 110, 140 are placed along the entire length of each cable 100, but most of them are omitted from FIG. 1 for clarity of illustration. The direction along cables 100 is termed inline, and the horizontal direction perpendicular to the cables is termed cross-line. Typically, the inline distance between sensor stations 110, i.e. along the cables 100 are 50 m. The cross-line distance, i.e. between cables 100 is typically in the range 200-500 m. For simplicity of illustration, all cables 100 run in the x-direction. Dashed lines 20 through the sensor stations 110 in the y-direction are not physical connections, but illustrates that the seismic array 5 may be mapped to a polygonal mesh representing the solid surface. If desired, e.g. for computational purposes, the quadrilateral mesh may be represented by a triangular mesh in a known manner. In either case, the seismic stations 110 or 140 are located at corners of the mesh.

FIG. 1 also illustrates consequences of subsidence such that the cables 100 sinks to new positions illustrated by dashed lines 101. More particularly, a point 150 on the solid surface subsides a distance dz in the vertical direction z. The shift dz at vertex 150 will shift an adjacent seismic station 140 downward, e.g. to the position illustrated by the dotted circle below seismic station 140. The shift dz also increases the tilt 141 in the inline direction at seismic sensor 140 by an angle α. A corresponding downward shift is shown at vertex 151 of the grid, and a change of tilt in the cross-line direction y is illustrated by an angle β.

For useful subsidence measurements, vertical displacement less than 10 cm should be detectable. Thus, 50 m between seismic stations in the inline direction corresponds to an angle α<arctan(10⁻²/50)=0.2°. Similarly, a cross-line spacing of 200 m corresponds to β<0.06° and a cross-line spacing of 500 m corresponds to β<0.02°.

It is possible to detect subsidence by mapping a polygonal mesh to the solid surface, e.g. the seafloor above a formation, and monitoring the mesh in a time-lapse sequence. In this case, tilt sensors within the seismic stations 110, 140 could provide spatial derivatives in the x and y-directions. If each tilt sensor is able to detect tilt changes less than 0.06° and the spacing of the cables 100 is less than 200 m, then the edges of the mesh are easily determined. In addition or alternatively, the corners of the mesh may be determined by pressure sensors capable of detecting pressure changes less than approximately 10⁻¹m/(10 m/bar)=0.01 bar.

However, the tilt sensors within the seismic stations 110, 140 are generally not designed with the accuracy discussed above. Similarly, some or all seismic stations 110, 140 may lack pressure sensors with the required sensitivity and/or means to filter noise in pressure data due to waves on the surface.

However, it may be possible to use statistical analysis to cancel out presumed stochastic variations in accuracy of the tilt sensors already present in the seismic stations 110, 140. If so, it will also be possible to provide those seismic stations 110, 140 that do not already have tilt sensors with relatively inexpensive tilt sensors, typically based on MEMS accelerometers.

Returning to FIG. 1, it is seen that the tilt 141 at sensor 140 is changed due to the greater curvature in the x-z plane after subsidence, i.e. after the downward shift dz at vertex 150. Thus, if tilt is measured as a deviation from the horizontal direction as indicated by arrow 141, the sum of all tilts in the x-z plane taken along the dotted line 101 will be greater than the same sum taken along the solid line 100. Furthermore, this assumption holds even if a real cable 100 deviates from the x-z plane, i.e. curves slightly in the x-y plane. In other words, a sum of deviations in the inline direction is equivalent to a sum in the x-direction. Depending on the implementation of the tilt sensors, this difference may or may not obviate a scalar product between a measured tilt and a unit vector in the x-direction, or a similar trigonometric computation, to obtain the tilt direction in the x-z plane. The sum of tilts along one cable 100 will be termed a cumulative inline tilt in the following.

From FIG. 1 it is also apparent that similar changes in curvature due to subsidence occur at the cable 100 running through vertex 151, and in other cables. A sum of cumulative inline tilts of several or all cables 100 is expected to be an even better measure of change of curvature, i.e. presence of subsidence, as the summed tilt difference grows systematically if the solid surface has subsided, while random inaccuracies in the tilt sensors continue to cancel each other.

A similar argument applies to the cross-line direction. The angle β implies a greater tilt in the y-z plane, which is equivalent to the cross-line direction. The sum of tilts along one cross-line 10, 20 is termed a cumulative cross-line tilt, and a sum of cumulative cross-line tilts of several or all cross-lines 10, 20 is expected to provide a better indication of subsidence than each individual cumulative cross-line tilt.

In short, the sum of cumulative inline tilts, possibly added to the sum of cumulative cross-line tilts, provides a fast and accurate indication of the presence of subsidence. Obviously, the presence of an uprise could be determined in the same manner.

Alternatively or additionally, there may be a desire to map the solid surface by means of inexpensive tilt sensors rather than just determine the presence of subsidence or uplift as discussed above. It is readily seen that regression analysis or known interpolation techniques can be employed inline and cross-line to obtain estimates for edges of the polygonal mesh, and hence quantitative estimates for curvature etc., using the ideas discussed above.

So far, the basic observed variable, i.e. tilt, has been described as deviation from a horizontal plane, i.e. the x-y plane in FIG. 1, for ease of explanation. However, conventional tilts, i.e. deviation from a vertical, work equally well, as displacing all angles by 90° or π/2 changes the sums, but does not change the basic ideas. Furthermore, any basic variable measuring the different curvature of inlines 100 and 101 and/or the cross-lines can be used without changing the basic ideas of obtaining cumulative sums inline and/or cross-line, and then summing the cumulative sums. Thus, the term ‘tilt’ as used herein should be understood as any such basic variable that can be derived from tilt sensor measurements, and is not limited to angular deviation from a horizontal as in the previous example.

The direction of tilt must of course be preserved in order to detect a difference between subsidence and uplift, whereas a sum involving squared basic variables may be employed if only subsidence or only uplift are of interest. Also, partial sums may be used if some part of the solid area is prone to uplift and other parts are prone to subsidence. Selecting suitable basic variables and constructing appropriate sums are considered well within the capabilities of one skilled in the art knowing the present disclosure and knowing the application at hand.

Thus, while the invention has been described by way of examples, the scope of the invention is determined by the accompanying claims.

1-10. (canceled)

11. A method for measuring subsidence and/or uprise on a field, comprising the steps of:
deploying at least one cable on a solid surface;
collecting inline tilt data from numerous tilt sensors deployed along each cable; and
performing a statistical analysis on the tilt data to determine changes in curvature on the solid surface.

12. The method according to claim 11, wherein the statistical analysis involves computing a cumulative inline tilt as a sum of collected tilt data from tilt sensors disposed along one cable.

13. The method according to claim 12, further comprising the step of adding several cumulative inline tilts.

14. The method according to claim 11, wherein the statistical analysis involves computing a cumulative cross-line tilt as a sum of collected tilt data from tilt sensors disposed along one cross-line extending perpendicular to several essentially parallel cables.

15. The method according to claim 14, further comprising the step of adding several cumulative cross-line tilts.

16. The method according to claim 11, further comprising the step of repeating the steps at predetermined intervals.

17. The method according to claim 11, further comprising the step of performing a regression analysis on the tilt data in order to obtain an estimate of a curvature on the solid surface.

18. The method according to claim 11, wherein a sign of tilt data is conserved to provide a difference between subsidence and uplift.

19. A system measuring subsidence and/or uprise on a field, comprising several cables with seismic stations arranged at regular intervals, each seismic station comprising a tilt sensor and the cables being arranged essentially parallel in an array, wherein each seismic station is connected through the array at base station and an umbilical to a control unit for performing the method of claim 11.

20. The system according to claim 19, wherein the solid surface is a seafloor above a subsurface formation to be monitored.
